(19) United States
(12) Patent Application Publication
(10) Pub. No.: US 2002/0166764 A1
(43) Pub. Date: Nov. 14, 2002

(54) Electrochemical sensor devices and methods for fast, reliable, and sensitive detection and quantitation of analytes

(75) Inventor: Robert D. MacPhee, Los Angeles, CA (US)

Correspondence Address: LYON & LYON LLP, 633 WEST FIFTH STREET, SUITE 4700, LOS ANGELES, CA, 90071, US

(73) Assignee: University of Southern California

(21) Appl. No.: 10/120,256

(22) Filed: Apr. 9, 2002

Related U.S. Application Data
(63) Continuation of application No. 09/249,532, filed on Feb. 11, 1999, now abandoned.
Application No. 09/249,532 is a continuation-in-part of application No. 09/105,538, filed on Jun. 26, 1998, now abandoned.
Application No. 09/249,532 is a continuation-in-part of application No. 09/105,539, filed on Jun. 26, 1998, now abandoned.
(60) Provisional application No. 60/055,466, filed on Aug. 12, 1997.
(60) Provisional application No. 60/055,759, filed on Aug. 14, 1997.

(51) Int. Cl. G01N 27/416

(52) U.S. Cl. 204/403.14; 205/777.5

(57) ABSTRACT

A device and reporter system wherein an electrochemical assay is performed on attractable beads which are attracted onto an electrochemical sensor for measurement of the electrochemically active molecules generated by the assay in proportion to the presence and quantity of the analyte.

### CROSS-REFERENCE TO RELATED APPLICATIONS

This application is a continuation-in-part of U.S. application Ser. No. 09/105,538, filed Jun. 26, 1998, and a continuation-in-part of U.S. application Ser. No. 09/105,539, filed Jun. 26, 1998, and claims benefit to U.S. Provision Application Nos. 60/055,466 and 60/055,759 filed Aug. 12, 1997 and Aug. 14, 1997 respectively, each of the above-identified references incorporated herein by reference

### FIELD OF THE INVENTION

The present invention relates to devices and methods for detecting and quantitating specific analytes in a sample.

### BACKGROUND OF THE INVENTION

As explained in greater detail in the parent applications, the detection and quantitation of specific analytes in samples is in important activity in environmental, health, biotechnology, industrial chemistry, and other fields. The analytes detected or quantitated may be any compound of interest for which there is a specific recognition molecule. Well known recognition molecules include proteins, such as receptors, immuno-globulins, and the like; nucleic acids, their analogs, and the like; haptens; hormones, and the like; certain drugs; and the like.

The parent applications also detail devices and techniques for detecting analytes that are known in the art, including ELISAs, RIAs, PCR, and the like. Although these techniques have proven very powerful, effective and valuable, they suffer from several drawbacks.

Most devices and techniques presently used for the detection of analytes require long incubations with the sample and special reaction and detection conditions. Special conditions include temperatures in excess of room temperature, incubations with the specimen as long as 30 minutes, or more, extensive washing between incubations, incubation with the labeling conjugate for as long as 30 minutes, or more, incubation with the substrate for 10 minutes or longer, and the requirement for the strictly timed inactivation of labeling enzyme-substrate solution.

Decreasing the time necessary to perform an assay while maintaining the precision, sensitivity, reliability and dose-dependent results obtained using conventional methods presents great economic advantages and in the case of laboratory medicine, the patient's well-being. In addition, the reduced need for extensive washing steps and special conditions (like an elevated temperature) decrease the likelihood of errors and decrease the possibility of machine failures and machine downtime.

### SUMMARY OF THE INVENTION

In a first, independent aspect of the present invention, an electrochemical sensor includes an interdigitaTed array of electrodes on a substantially dielectric substrate and a means for temporarily concentrating reagents on the surface of the interdigitated array of electrodes.

In a second, independent aspect of the present invention, an electrochemical reporter system includes a recognition molecule capable of specifically binding an analyte in a structure restricted manner linked to a magnetic bead, a coupling element for coupling with specificity an enzyme to the recognition molecule or the analyte, a substrate, which in the presence of the enzyme is cleavable into a reporter molecule capable of exhibiting redox recycling, a sensor for detecting the electrochemical reporter molecule and having a configuration such that the reporter molecule will exhibit redox recycling, and a magnetic field generating device positioned such that the magnetic beads may be attracted to the surface of the sensor.

In a third, independent aspect of the present invention, an electrochemical reporter device includes a chamber for receiving an analytical reaction comprising magnetic beads, a sensor on the surface of the chamber, the sensor for detecting electrochemical reporter molecules within the chamber and the sensor having a configuration such that reporter molecules capable of exhibit redox recycling will undergo redox recycling if within the chamber, and a magnetic field generating device that may be positioned such that magnetic beads present within the chamber will be attracted to the surface of the chamber wherein the sensor is located.

In a fourth, independent aspect of the present invention, an electrochemical reporter system includes a magnetic bead, a recognition molecule capable of specifically binding an analyte in a structure restricted manner, the recognition molecule being linked to the magnetic bead, an enzyme, a coupling element for coupling with specificity the enzyme to the recognition molecule or the analyte, a substrate which in the presence of the enzyme is cleavable into a reporter molecule capable of exhibiting redox recycling, a sensor for detecting the electrochemical reporter molecule and having a configuration such that the reporter molecule will exhibit redox recycling, and a magnetic field generating device positioned such that the magnetic beads may be attracted to the vicinity of the sensor.

In a fifth, independent aspect of the present invention, an assay for detecting or quantitating a specific analyte in a sample comprising the steps of a primary incubation, wherein magnetic beads coated with a recognition molecule that specifically binds an analyte are incubated with the sample, a secondary incubation, wherein the magnetic beads are incubated with a conjugate comprising an enzyme, and a molecule that specifically binds the analyte, or the analyte/recognition molecule complex, capturing the magnetic beads with a magnet over a sensor capable of producing redox recycling of an electrochemical capable of undergoing redox recycling, adding a substrate in the presence of the enzyme being cleaved into an electrochemical capable of undergoing redox recycling, and detecting the presence or measuring the amount of electrochemical present in the solution with the sensor.

In a sixth, independent aspect of the present invention, an electrochemical immunoassay for detecting an analyte in a sample includes the steps of having a magnetic bead linked to an antigen with an antibody specific for an analyte bound to the antigen, the antibody being coupled to an enzyme or having a coupling element for being specifically coupled to an enzyme, contacting the magnetic bead/antigen/antibody/enzyme complex with a sample to be analyzed, collecting the magnetic bead/antigen/antibody/enzyme complex, attracting the magnetic bead/antigen/antibody/enzyme complex to the vicinity of a sensor, adding a substrate to the collected magnetic bead/antigen/antibody/enzyme complex in the presence of the enzyme being cleavable into a reporter molecule capable of exhibiting redox recycling, and measuring the presence or amount of reporter molecule with the sensor, the sensor being an interdigitated array of electrodes capable of producing redox recycling of the reporter molecule.

In a seventh, independent aspect of the present invention, an electrochemical immunoassay for detecting a specific analyte in a sample includes the steps of having a recognition molecule linked to a magnetic bead and capable of specifically binding the analyte in a structure restricted manner, contacting the magnetic bead with a sample to be analyzed, coupling with specificity an enzyme to the recognition molecule or the analyte, attracting the magnetic bead/recognition molecule/analyte/enzyme conjugate complex to the vicinity of a sensor with a device capable of generating a magnetic field, adding a substrate, which in the presence of the enzyme is cleaved into a reporter molecule capable of exhibiting redox recycling, and measuring the presence or amount of electrochemical with the sensor, wherein the sensor is an interdigitated array of electrodes capable of producing redox recycling of the electrochemical.

In an eighth, independent aspect of the present invention, an electrochemical reporter system includes a magnetic bead, a recognition molecule capable of specifically binding an analyte in a structure restricted manner, the recognition molecule being linked to the magnetic bead, an enzyme, a coupling element, for coupling with specificity the enzyme to the recognition molecule or the analyte, a substrate which in the presence of the enzyme is cleavable into a reporter molecule capable of exhibiting redox recycling, a sensor for detecting the electrochemical reporter molecule and having a configuration such that the reporter molecule will exhibit redox recycling, and a magnetic field generating device positioned such that the magnetic beads will be attracted to the vicinity of the sensor.

### BRIEF DESCRIPTION OF THE FIGURES

FIG. 1 is a schematic representation of a device in accordance with the present invention for a detecting and/or quantitating a specific analyte in a sample.

FIG. 2 is a graph of the nAmps measured when assaying serum samples having low, medium and high anti-p24 levles.

FIG. 3 is a graph plotting the slope of the kinetic measurment (nA/s) against the original concentration (mIU/ml) of HBsAg in the sample.

FIG. 4 is a dose response curve using electrochemical measurement according to the present invention.

FIG. 5 are measurements of different concentrations using electrochemical measurement with a device without the magnetic 5 beads and magnet of the present invention.

FIG. 6 is a comparison of the use of different number of beads per sample.

FIG. 7 is a flow chart of methods and devices in accordance with the present invention.

### DETAILED DESCRIPTION OF THE PREFERRED EMBODIMENTS

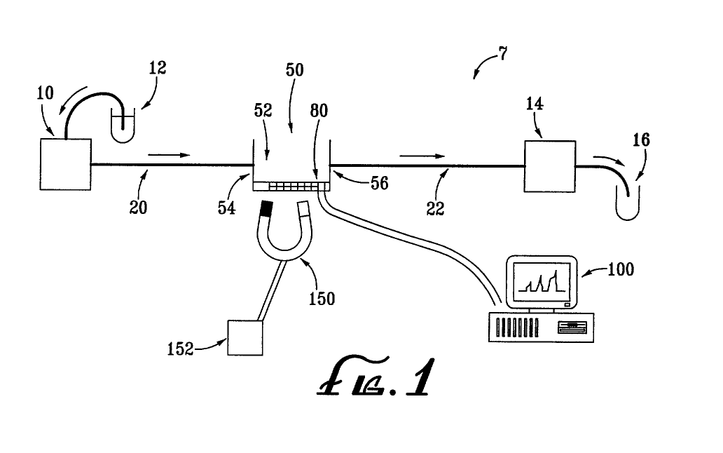

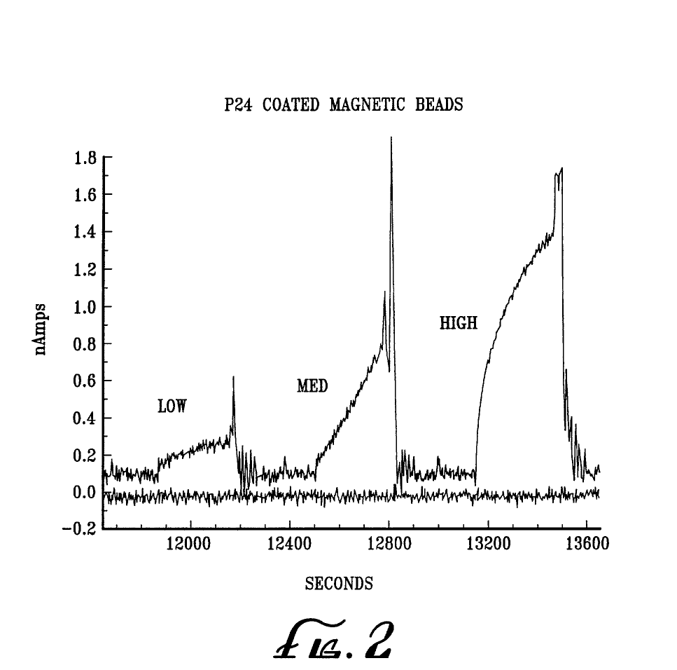

Turning in detail to the drawings, FIG. 1 is a schematic representation of a device 7 in accordance with the present invention for a detecting and/or quantitating a specific analyte in a sample. A first pumping device 10 draws a processed sample 12 and forces the sample to flow through a first tubing segment 20 into the electrochemical sensing device 50.

The first pumping device 10 may be any device that can draw fluids containing small particles and pump them through a tubing segment. Preferably, the first pumping device 10 is a peristaltic pump with adjustable speeds.

The first tubing segment 20 may be any tubing that can carry a fluid having small particles without clogging. It is preferably of an inert material, i.e. a material that will not interact detrimentally with the fluids and reagents flowing within it. Most preferably, the first tubing segment 20 is TYGON tubing.

The diameter of the first tubing segment 20 will depend on the rate of flow desired. In general, the rate of flow of fluids through the tube 20 can be increased by using tubing having a wider inner diameter, or by accelerating the rate of the first pumping device 10. Conversely, a slower rate of flow can be achieved by using tubing having a smaller diameter. Preferably, the first tubing segment has an inner diameter such that an appropriate rage of flow may be achieved. The tubing diameter will also depend on the size of the beads and the function of the fluid being delivered, as the diameter of the tubing will alter the rate of flow of the fluid therein.

The electrochemical sensing device 50, includes an inflow orifice 54, a chamber 52 for holding the sample, an outflow orifice 56 and a sensor 80. The outflow orifice 56 is connected to the outflow tubing 22 which leads to a second pumping (drawing) device 14 (shown in the figure), or alternatively the first pumping device 10 may also be used for this purpose, in which case the system needs to be hermetically sealed. The flow is then directed to a waste receptacle 16, collecting chamber, or the like. If two pumps are used, less flexible, more inert material can be used for the tubing, including TEFLON, or the like.

The sensor 80 may be any device that can detect or measure an electrochemical that can undergo redox recycling, while providing for the redox recycling of the electrochemical. Preferred is an interdigitated array of electrodes (IDA) with a spacing between the electrodes smaller than about 800 μm. Most preferred is an array of electrodes with a spacing between the electrodes between about 200 and about 400 μm.

The sensor 80 may have one or more IDAs. More IDAs provide for greater sensitivity, but have been found not to be indispensable. When more than one array is present, (i.e. a “ganged” IDA sensor) the arrays may be linked in series or in parallel. Independent combinations thereof may also be used.

The sensor 80 is linked to a system controller 100 including a multipotentiostat that provides specified potential across the IDAs and measures the dose dependent amperage resulting from redox recycling of reporter electrochemicals proximal to the IDA. Alternatively, the information may be derived by scanning voltametry, or the like. The system controller is thus capable of measuring and preferably also recording the change in voltage, and/or amps, and the like, in the IDA. If more than one IDA is present in series, the system controller 100 preferably can record the change occurring in each independent IDA or the sum of such changes.

A magnetic field generating device 150, or the like, is positioned relative to the electrochemical sensing device 50 and is of a strength such that when it generates a magnetic field, magnetic particles in a fluid within the chamber 52 will be attracted onto the sensor 80 surface. The magnetic field generating device 150 may be activated/deactivated by an on/off switch 152, or the like. The switch may be under the control of a system controller 100, or the like. Alternatively, the magnetic field generating device 150 may be a permanent magnet moveable such that in at least a first position, the magnetic field it generates affects magnetic particles within chamber 52, causing the magnetic particles to be attracted onto the sensor surface 80, and in a second position, such that the magnetic field does not significantly affect magnetic particles within chamber 52.

In use, a buffer is pumped through the system and over the sensor 80 until the baseline recorded in the system controller 100. Any effective buffer may be used, but enzyme substrate buffer (ESB) is preferred. The buffer may be flowed over the sensor 80 at any effective rate, however, a slow rate (about 0.2 mL/min) is preferred.

The magnet 150 under the sensor 80 may then be activated 152, or, alternatively, a magnet may be placed under the sensor 80. The magnet 150 should be of a quality and should be placed such that it generates a field of force sufficient to capture magnetic beads on the surface of the sensor 80.

The sample to be tested 12 is then circulated over the sensor 80. One method by which the sample may be prepared is described in more detail infra, although the sample may be prepared by other methods. In general, the sample includes magnetic beads, or the like, and an enzyme indirectly linked to the magnetic beads by the analyte, the recognition molecule or a combination thereof. The bead solution may be circulated for any effective amount of time such that the beads are captured by the magnet 150 over the sensor 80 surface. Preferably, the bead solution is circulated for approximately 2 minutes at medium to fast flow rates (approximately 0.38 mL/min). The effect of the magnet 150 and the flow rate should be such that a high concentration of beads is captured over the sensor surface 80.

A substrate may then be circulated over the sensor 80. The substrate may be circulated at any effective rate, however, a slow flow rate (approximately 0.2 mL/min) is preferred. The flow is then preferably stopped while substrate solution is over the sensor 80 and the signal is measured and/or recorded by the system controller 100 with no flow for the desired period of time. The signal may be measured for any necessary amount of time. In general, however, the signal may be measured for about 90 to about 100 seconds or about 60 seconds of useable data. Longer or shorter measurements may be used if necessary. It is within the skill in the art to determine the optimal length of time the measurement should take place for a given set of conditions and samples.

The substrate will depend on the enzyme and the conditions used. Any effective substrate may be used. A non-limiting list of enzyme/substrate pairs that may be used in accordance with the present invention is disclosed in the parent applications U.S. application Ser. Nos. 09/105,538 and 09/105,539. Any effective concentration of substrate may be used. The preparation of the substrate solution is described in detail infra.

Once the sample has been assayed, the beads may be cleared from the sensor 80 surface by deactivating 152, or removing, the magnet 150 from the proximity of the sensor 80, and circulating fresh buffer at a sufficiently rapid rate of flow over the sensor 80. Any effective buffer may be used, but ESB is preferred. The rate of flow is preferably about 0.43 mL/min. The addition of bubbles to the buffer flow has been found to assist the clearance of the beads. The washing buffer may be applied for any effective amount of time, however, generally between about 45 and 60 seconds has been found to be sufficient. Once the beads are washed out, fresh buffer may be recycled over the sensor 80 until the baseline equilibrates again. This step generally takes about 30 seconds. The sensor 80 is then ready for a new sample.

Another aspect of the present invention is a fast and reliable assay for measuring and quantitating analytes in a sample. The method is particularly effective when used with the device of the present invention.

In general, the assay uses magnetic beads, or the like, which are commercially available. Any effective magnetic beads may be used, however Tosyl-activated DYNABEADS M-450 (DYNAL Inc, 5 Delaware Drive, Lake Success, N.Y. 11042 Prod No. 140.03, 140.04,) or the like, are preferred. Other magnetic beads may be used, and are generally coated by dissolving the coating material in carbonate buffer (pH 9.6, 0.2 M) or the like, or any other well known in the art method. The magnetic beads may be of any size that can be held to the chip surface with the magnet.

The magnetic beads are coated with a recognition molecule that binds to the analyte to be detected or quantitated with specificity and high affinity. Methods for coating magnetic beads with specific recognition molecules is well known in the art. For the DYNABEADS, the instructions provided by the manufacturer may be used. Briefly, the magnetic beads are first resuspended and homogenized by vortexing, or the like, and a volume corresponding to the number of beads desired is pipetted into a test tube. The magnetic beads are concentrated using a magnet, and the supernatant is pipetted off, leaving the magnetic beads undisturbed. The beads are then resuspended in an ample volume (original volume) of any effective buffer. It is within the skill in the art to determine the most effective buffer for the recognition molecule to be used. Buffers that may be used include, for example, phosphate buffer pH 7.4, borate buffer pH 9.5 or acetate buffer pH 4.0 with molarities between 0.1 and 0.5 M. The beads are mixed gently for about 2 minutes with the buffer.

It is preferred that the molarity of salt in the final coating solution not be less than 0.05M. Higher pH and/or higher temperature will give a quicker formation of chemical bonds. The upper pH and temperature limit is determined by the recognition molecule used to coat the magnetic beads.

The magnetic beads are once more concentrated with a magnet, and the supernatant pipetted off leaving the beads undisturbed. The beads are then resuspended in an appropriate volume of phosphate buffer pH 7.4, borate buffer pH 9.5 or acetate buffer pH 4.0. The beads are now ready for coating.

For coating, the magnetic beads are thoroughly resuspended in phosphate buffer pH 7.4, borate buffer pH 9.5 or acetate buffer pH 4.0. From between about 1 μg to about 10 μg of the pure recognition molecule, if it is a protein, polypeptide or the like, per 10⁷ magnetic beads is added to the magnetic bead/buffer solution. Preferably, about 5 μg of the pure recognition molecule, if it is a protein, polypeptide or the like, per 10⁷ magnetic beads is added to the magnetic bead/buffer solution. The solution is then vortexed for 1-2 minutes. The manufacturer of DYNABEADS recommends a concentration of 4-10×10⁸ DYNABEADS per ml final coating solution (including the antibody).

The magnetic beads/antibody solution may then be incubated for 16-24 hours at 37° C. with slow tilt rotation, or the like. Lower temperatures may be used for temperature sensitive recognition molecules. Higher temperatures and shorter incubation times may be used for stable recognition molecules. It is essential that the beads are not permitted to settle during the incubation period.

Phosphate buffer pH 7.4 (0.1M) may be prepared with 2.62 g Na H₂ PO₄xH₂O (MW 137.99) and 14.42 g Na₂HPO₄x2H₂O (MW 177.99) dissolved in distilled water and adjust the volume to 1000 ml.

Borate buffer pH 9.5 (0.1M) may be prepared with 6.183 g H₃BO₃ (MW 61.83) dissolved in 800 ml distilled water, and adjusting the pH to 9.5 using 5M NaOH and then adjusting the volume to 1000 ml with distilled water.

Acetate buffer pH 4.0 (0.1M) may be prepared with 2.86 ml acetic acid (CH₃COOH), adding 900 ml distilled water, adjusting the pH to 4.0 using 5M NaOH and adjusting the volume to 1000 ml with distilled water.

These buffers may be used for prewashing and coating of Dynabeads M-450 Tosylactivated. It is preferred that no proteins, sugars, or the like be added to these buffers.

Recognition molecules other than proteins or polypeptides may also be directly or indirectly used to coat the magnetic beads. For example, nucleic acids and their analogs can be attached to the magnetic beads by an avidin biotin link, or the like; by binding the nucleic acid or analog to a protein like albumin or the like, which is then used to coat the magnetic beads; or by other methods well known in the art. Other recognition molecules, including hormones, haptens, sugars, and the like may similarly be bound to the magnetic beads using strategies well known by those of skill in the art.

After the incubation, the magnetic beads are concentrated using a magnet, and the supernatant is pipetted off. The coated beads are then washed a total of four times. Twice in buffer D for 5 minutes at 4° C., once in buffer E for 24 h at 20° C. or for 4 hours at 37° C., and once in buffer D for 5 minutes at 4° C. The beads should be coated and ready for use after this procedure. The amount of specific recognition molecules bound to the beads may be established by radioactive labeling, immunofluorescent methods or spectrophotometry.

The beads may be stored in buffer D at 4° C., usually for months, depending on the stability of the immobilized material. If the beads are stored for more than two weeks, it is preferred that they be washed twice in PBS/BSA for five minutes before use.

Buffer D consists generally of PBS pH 7.4 with 0.1% (w/v BSA(HSA). Add 0.88 g NaCI (MW 58.4) and 0.1% (w/v) BSA or HSA to 80 ml 0.01M Na-phosphate pH 7.4 (see above). Mix thoroughly and adjust volume to 100 ml with 0.01M Na-phosphate pH 7.4.

Buffer D is used for washing and coating of all precoated dynabeads. This buffer or any buffer containing protein or amino-groups (glycine, Tris etc.) should preferably not be used for pre-washing or coating of Dynabeads M-450 Tosylactivated. If a preservative is needed in the coated product, an effective amount of sodium azide (NaN₃) may be added to buffer D. Preferred is a final concentration of 0.02% (w/v). This preservative is cytotoxic and must be carefully removed before use by washing. Required safety precautions must be followed when handling this material.

Buffer E: 0.2M Tris pH 8.5 with 0.1% (w/v) BSA(HSA) Dissolve 2.42 g Tris in 80 ml distilled water. Adjust pH to 8.5 using 1 M HCI. Add 0.1% BSA/HSA and adjust volume to 100 ml.

All reagents used should preferably be analytical grade.

After coating the beads with the appropriate recognition molecule, the desired number of beads are washed in MBE and resuspended in the desired volume of MBE. Any number of beads per volume may be used. In general, however, between about 4-5×10⁴ and about 4-5×10¹⁰ beads may be used for an assay having a final volume of 40 μl. Preferably, between about 4-5×10⁵ and about 4-5×10⁷ beads may be used for an assay having a final volume of 40 μl. Most preferred is the use of between about 4-5×10⁶ and about 1×10⁷ beads for an assay having a final volume of 40 μl.

The primary incubation in general consists of adding the sample to be analyzed to the magnetic beads pre-coated with the recognition molecule. In general, the volume in which the beads are carried will depend on the number of beads to be used and the final volume at which the reaction will take place. In general, however, when between about 4-5×10⁶ and about 1×10⁷ beads in 20 μl may be used.

Any sample generally tested using conventional techniques may also be tested using the methods and devices of the present invention. The sample may be diluted in MBE if necessary. In general, for example, it has been found that serum samples may be diluted 1:2 or 1:4, or even greater if the analyte is present in sufficient concentrations. Diluting the sample has been found to decrease the background.

The sample and the beads are then mixed, generally in a 1:1 (v/v) ratio. Preferably, 20 μl of beads and 20 μl of sample are mixed, for a total reaction volume of 40 μl.

Several experiments have been performed in which the primary incubation time period was examined, with time incubation time intervals ranging from about 0.5 of a minute to about 30 minutes. Although longer incubations were found to yield more sensitive results, in general primary incubations of about 10 minutes or less were found to yield highly sensitive results. Primary incubations of about 5 minutes or less were also found to yield highly sensitive results. Most preferred are primary incubation of between about 1 and about 2 minutes.

The beads are then washed twice with MBE (100 μl per 40 μl in the primary incubation may be used). The secondary incubation with a molecule that specifically binds the analyte and is conjugated or may be conjugated to an enzyme is then effectuated. Any effective amount and concentration of the conjugate may be used. Preferably, however, the secondary incubation takes place in the same volume as the primary incubation. The conjugate may be diluted in MBE, as necessary.

Secondary incubations ranging in time from about 0.5 of a minute to about 30 minutes were tried. Although longer incubations were found to yield more sensitive results, in general secondary incubations of about 10 minutes or less were found to yield highly sensitive results. Secondary incubations of about 5 minutes or less were also found to yield highly sensitive results. Most preferred are secondary incubations of between about 1 and about 2 minutes. The solution is preferably gently rocked during the procedure to ensure mixing of the reaction components.

It was found that when the systems and methods of the present invention are used, the primary and secondary incubations may be performed at room temperature (17° C.-25° C.), with excellent results. Higher or lower temperatures may be used if appropriate.

The liquid phase is then discarded and the reaction washed. In general, the reaction is washed three times in PBS with 0.05% Tween 20. Prior to injection into the device, the reaction is washed with ESB, and the reaction resuspended in ESB. In general, with the device described above, the reaction is resuspended in 200 μl.

The substrate to be used will depend on the enzyme in the conjugate. In general, if the enzyme is beta-galactosidase, an effective substrate is PAPG. A concentration of 2 mM is preferred. A non-exclusive list of enzymes and substrates is disclosed in the parent applications U.S. application Ser. Nos. 09/105,538 and 09/105,539.

### EXAMPLES

Experiments were conducted to evaluate faster, more sensitive devices and methods for detecting and quantitating analytes based on the proportional production of an electrochemical capable of undergoing redox recycling and the measurement of the electrochemical with an IDA having a conformation such that the electrochemical will undergo redox recycling.

Unless otherwise specified, the following materials were used. M450 Tosyl-activated magnetic beads (Dynal, Product No. 140.04). Coating buffer 0.1 M Phosphate Buffer Saline (PBS), pH 7.4. Post-coating washing buffer PBS, pH 7.4 with 0.1% (w/v) bovine serum albumin (BSA)(1× crystallized, Sigma, cat# A-4378). Storage buffer, PBS, pH 7.4 with 0.1% (w/v) BSA and 0.02% (w/v) sodium azide. Tosyl blocking buffer, 0.2 M Tris Buffer, pH 8.5, with 0.1% (w/v) BSA. Recombinant HIV-1 p24 antigen (Devaron, Inc., cat# 301-8-2, clone # AR-DEV). Human serum derived hepatitis B surface antigen AD subtype (adHBsAg)(Genzyme Diagnostics, Cat#ABH0707, Lot#M-22975). Recombinant HBsAg (ayw subtype) (Genzyme Diagnostics, Cat#ABH0705, Lot#M-22756). Goat anti-human (IgG H+L-specific) conjugated to beta-galactosidase (American Qualex, cat#A110GN, lot#GG017). P-aminophenyl-beta-D-galactopyranoside (Sigma, cat#A-9545) at 2 mM, in “Enzyme substrate buffer” (0.1 M Phosphate, 0.1 M NaCl, pH 6.8).

Modified buffer E (MBE), 0.2 m Tris buffer, pH 8.5, with 1.0% (w/v) BSA, is used in the coating to block the unbound, active tosyl groups. It has been found that by using Tris buffer with BSA, the assay is less likely to produce non-specific binding.

The experiments were performed with the following positive and negative controls. Human serum with antibody to p24: negative α-p24 (98-058-08445), approximate titer of 0; low+α-p24 (98-053-01456), approximate titer of 261; medium+α-p24 (98-062-07940), approximate titer of 1,515; and high+α-p24 (98-058-07537), approximate titer of 104,186. Human serum with antibody to HBsAg: high+α-HBsAg (98-306-04981), approximate concentration of 4742 mIU/ml; negative α-HBsAg (98-306-05415). Dilutions of high+α-HBsAg with the negative serum were used to produce samples with lower α-HBsAg titers.

A calorimetric assay was performed on the samples for comparative purposes. This calorimetric assay is a widely utilized non-electrochemical detection technique. For the calorimetric bead optical endpoint assays, peroxidase-Affinipure F(ab) fragment mouse anti-human IgG Fc (gamma) fragment specific (Jackson Immunoresearch, code 209-036-098, lot 25206) was used and OPD was obtained from Abbott kit products (OPD tablets no. 7181E, OPD diluent no. 5695).

### Example 1

The desired number of beads were washed in MBE and resuspended in the desired volume of MBE. In particular, 4-5×10⁶ beads were used for an electrochemical reaction, while 1×10⁶ beads were used in the optical reaction.

The primary incubation in general consists of adding the sample to be analyzed to beads (20 μl) pre-coated with the recognition molecule. For the test indicated below, the serum sample was diluted 1:4 in MBE (20 μl per well) for a total reaction volume of 40 μl.

Several experiments have been performed in which the primary incubation time period was examined, with time incubation time intervals ranging from about 0.5 of a minute to about 30 minutes. Although longer incubations were found to yield more sensitive results, in general primary incubations of 1-2 minutes were found to yield a high sensitivity.

The reaction was then washed twice with MBE (100 μl) and the beads incubated (secondary incubation) in goat-anti-human beta-galactosidase conjugate (40 μl per well, 1:1000 dilution in MBE). Incubations ranging in time from about 0.5 of a minute to about 30 minutes were tried. Although longer secondary incubations were found to yield more sensitive results. In general, however, incubations of 1-2 minutes were found to yield a high sensitivity. The solution is preferably shaken during the procedure to ensure mixing of the reaction components.

It was found that when the systems and methods of the present invention are used, the primary and secondary incubations may be performed at room temperature (17° C.-25° C.), with excellent results.

The liquid phase was then discarded and the reaction washed three times (100 μl) in PBS with 0.05% Tween 20. The reaction was then washed once (100 μl) with ESB, and the reaction resuspended in ESB (200 μl).

The sensor (a single array of an interdigitated array of electrodes as described in U.S. Pat. No. 5,670,031) was activated and ESB flowed over the sensor at a slow rate (about 0.2 mL/min) until a stable baseline was achieved. The magnet under the sensor was then placed under the sensor. The magnet was placed such that it generated a field of force sufficient to capture magnetic beads on the surface of the sensor.

The sample to be measured was then circulated over the sensor. The bead solution was circulated for approximately 2 minutes at medium to fast flow rates (approximately 0.38 mL/min). Due to the magnet, a high concentration of beads was captured over the sensor surface.

The substrate (2 mM PAPG, 100 μl) was then circulated over the sensor at a slow flow rate (approximately 0.2 mL/min). The flow was then stopped while substrate solution was over the sensor and the signal was measured with no flow for the desired period of time. The signal was measured for about 90 to about 100 seconds for 60 seconds of useable data.

The beads were cleared from the sensor by removing the magnet from the proximity of the sensor and circulating fresh ESB at a high flow rate (approximately 0.43 mL/min) over the sensor. The addition of bubbles to the ESB flow was found to assist the clearance of the beads. The washing step generally took between about 45 and 60 seconds. Once the beads were washed out, fresh ESB was recycled over the sensor until the baseline equilibrated. This step generally took about 30 seconds. The sensor was then ready for a new sample.

After coating the magnetic beads with p24, the beads were incubated for one minute with the serum to be tested (primary incubation), washed, incubated for one minute with goat anti human beta-galactosidase IgG (secondary incubation) and washed. The procedure described above was then used to concentrate the beads over the sensor and the substrate was added.

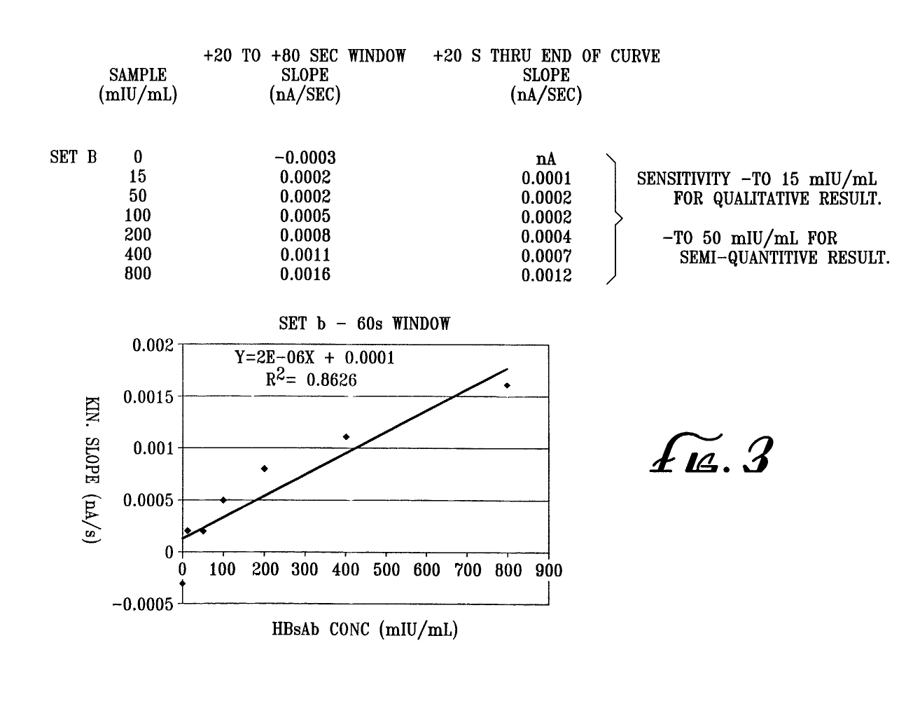

FIG. 2 is a graphical representation of the measured change in voltage over time. The first peak, starting at about t 11900 and ending at about t 12200 corresponds to the measurement of anti p24 in the low titer serum. The second peak, starting at about t 12500 and ending at about t 12800 corresponds to the measurement of anti p24 in the medium titer serum. The third peak, starting at about t 13200 and ending at about t 13500 corresponds to the measurement of anti p24 in the high titer serum.

The average slope was calculated from the data graph (nAmp=y-axis; time (seconds)=x-axis) for data points acquired from the 20th second through the 100th second of measurement. Data was acquired at the rate of 2 observations per second and recorded as spreadsheet entries by the acquisition program (Origin Software). For the low titer serum the average slope was estimated to be 0.061, the average slope for the medium titer serum was estimated to be 0.112, and the average slope for the high titer serum was estimated to be 0.344. These values can be compared to the optical measurements obtained using a commercially available kit. The optical measurement provided values of 0.147, 0.291 and 0.495 for the low, medium and high titer serums respectively. Advantageously, a tight correlation therefore was observed between the results obtained using the present invention and those obtained using commercially available systems. The results obtained using the present invention, however, required only a fraction of the time required for the commercially available system and method.

### Example 2

An experiment was conducted to find out the sensitivity of the system and method of the present invention under the conditions described below. Serial dilutions of human serum having concentrations equivalent to 0, 15, 50, 100, 200, 400 and 800 mIU/ml anti-HBsAg were prepared. Magnetic beads (DYNABEADS M450) which had previously been coated with HBsAg were washed and resuspended in MBE.

For the primary incubation, the serum samples were diluted 1:1 with MBE, and 25 μl of each diluted sample was dispensed in a microtiter plate well. In particular, 5×10⁶ coated beads in 25 μl MBE were then added to each well. The samples were incubated for 2 minutes with gentle rocking at room temperature. The samples were then washed twice with MBE.

For the secondary incubation, 50 μl of a 1:1000 dilution of goat anti human beta galactosidase conjugate in MBE was added to each well. The samples were incubated for 2 minutes with gentle rocking at room temperature. The samples were then washed twice with MBE, twice with PBST, once with ESB, and then resuspended in 250 μl. The samples were then individually loaded onto the chip. PAPG 2 mM in ESB was then added to the system and the voltage in the sensor recorded.

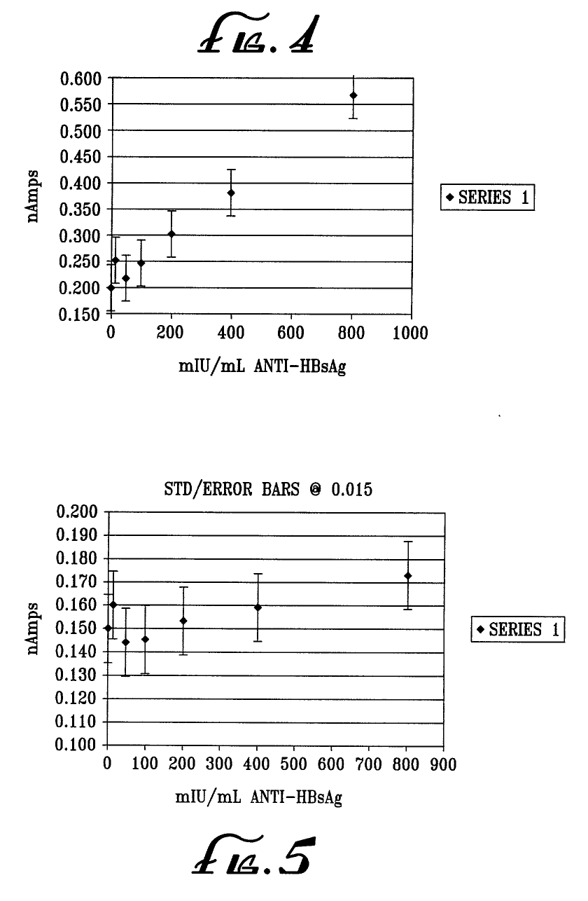

FIG. 3 is a graph plotting the slope of the kinetic measurment (nA/s) against the original concentration (mIU/ml) of HBsAg in the sample. The results indicate a correlation having an R2 equal to 0.8626. Qualitative results are obtainable for concentrations at least as low as 15 mIU/ml, with semiquantitative results obtainable from 50 mIU/ml or greater under these conditions. As shown in Example 4 infra, more sensitive results may be obtained by slightly varying the conditions.

### Example 3

In this set of experiments, hepatitis B surface antigen (HBsAg) levels in human serum were measured. The measurement of dilutions corresponding to 0, 15, 50, 100, 200, 400 and 800 mIU/ml were obtained using side by side matched conditions for all reagents. A direct comparison was made between the sensitivity of the methods and devices in accordance with the present invention and the devices and methods disclosed in the parent applications which are at least as sensitive and reliable as the calorimetric assay commercially availableto obtain a direct comparison between the system and method with and without the novel aspects of the present invention.

Preliminarily, DYNABEADS (M450) (4×10⁸) were coated with 200 μg of HBsAg (100 μg of ad subtype obtained from human plasma and 100 μg of ayw recombinant HBsAg) in a 850 μl reaction volume following the same protocol used for p24 in Example 1. In parallel, a substantially identical surface area of a microtiter plate was also similarly coated.

Sets of microbeads and microtiter plate wells were then incubated (primary incubation) with the different dilutions of HBsAg serum samples for two minutes at room temperature. After two minutes the samples were removed and the different sets of microbeads and the wells of the microtiter plates were washed. The microbeads and microtiter plate wells were then subjected to a two minutes secondary incubation with goat anti-human β-galactosidase. The conjugate was then removed and excess conjugate was washed off.

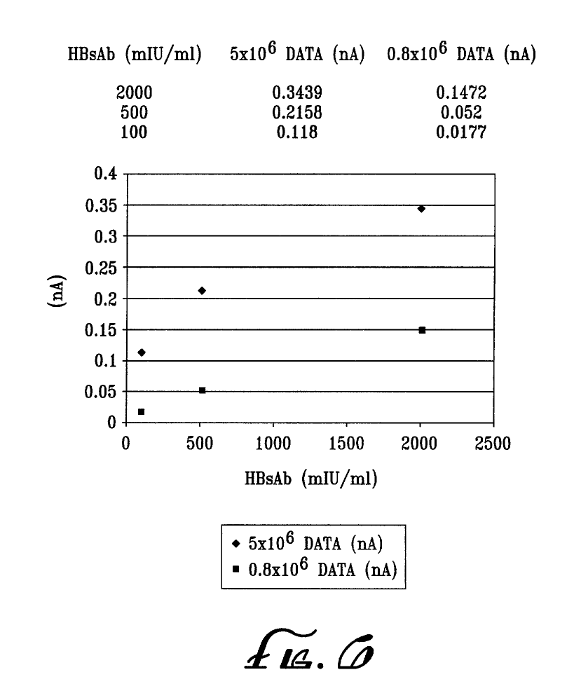

The microbead samples corresponding to the different dilutions of the sample were then individually measured by capturing the microbeads over the sensor, adding the substrate solution and measuring the change in voltage over a period of 60 seconds. FIG. 4 is graphic representation of the results obtained.

Similarly, the matched pairs measured in the microtiter plates were assessed by stopping the reaction after two minutes, and measuring in a traditional manner the electrochemical generated. FIG. 5 is a graphic representation of the results obtained.

As can be seen by comparing FIG. 4 to FIG. 5, the method and device of the present invention provides under these conditions a linear dose response that can qualitatively detect as low as 200 mIU/ml anti-HBsAg at 2 standard deviations uncertainty, with a linear dose response up to 800 mIU/ml. In contrast, the results obtained using the traditional method showed no statistically significant difference between the samples, i.e. the traditional method under these conditions does not demonstrate a measurable dose dependent increase in electrochemical, and in fact the traditional method under these conditions cannot qualitatively detect the analyte at a concentration below 800 mIU/ml.

The sensitivity and reliability of the method and device using the short primary and secondary incubations at room temperature was unexpectedly much greater than was expected. These properties of the methods and devices of the present invention are valuable because they permit faster, cheaper, less cumbersome analysis of a sample.

### Example 4

Having determined the unexpected and valuable properties of the system and method of the present invention, experiments were performed in order to optimize the procedure. In this experiment, the effect of the concentration of magnetic beads per sample to be analyzed was evaluated.

The experiment was generally set up as in Example 2. Serum samples having three concentrations (100 mIU/ml, 500 mIU/ml, 2000 mIU/ml) of HBsAg were tested using either 800,000 beads per sample, as in Example 2, or 5,000,000 beads per serum sample. The data was derived as in Example 2, and is shown graphically in FIG. 6.

The data from the experiment indicates that the sensitivity of the device and method can be further greatly enhanced by increasing the number of magnetic beads per volume of sample. This presents a further advantage over the traditional method since it permits an increase in the surface area over which reactions can take place. As may be seen from FIG. 6, a concentration of 100 mIU/ml can easily be detected using the larger amount of beads. Lower concentrations were not tested, but the linearity of the response indicates that concentrations as low as 15 mIU/ml should be easily obtained with the increased number of beads.

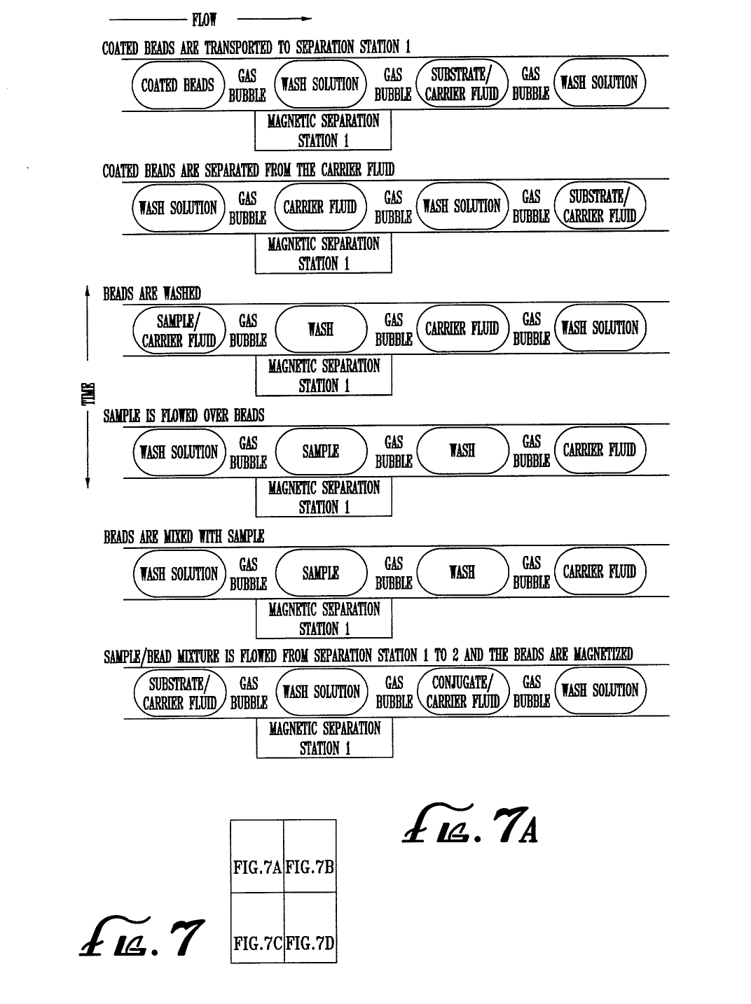

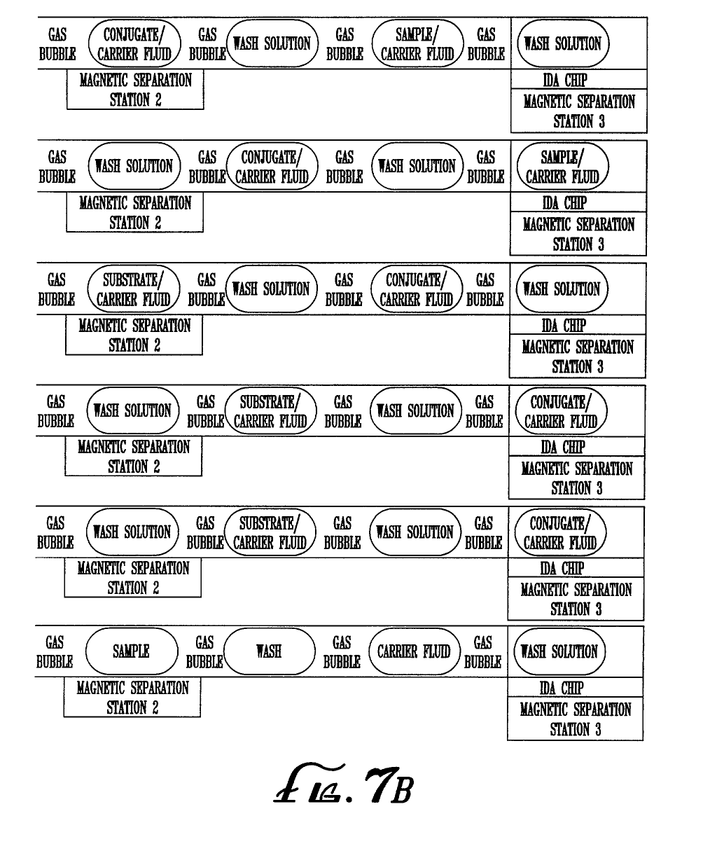

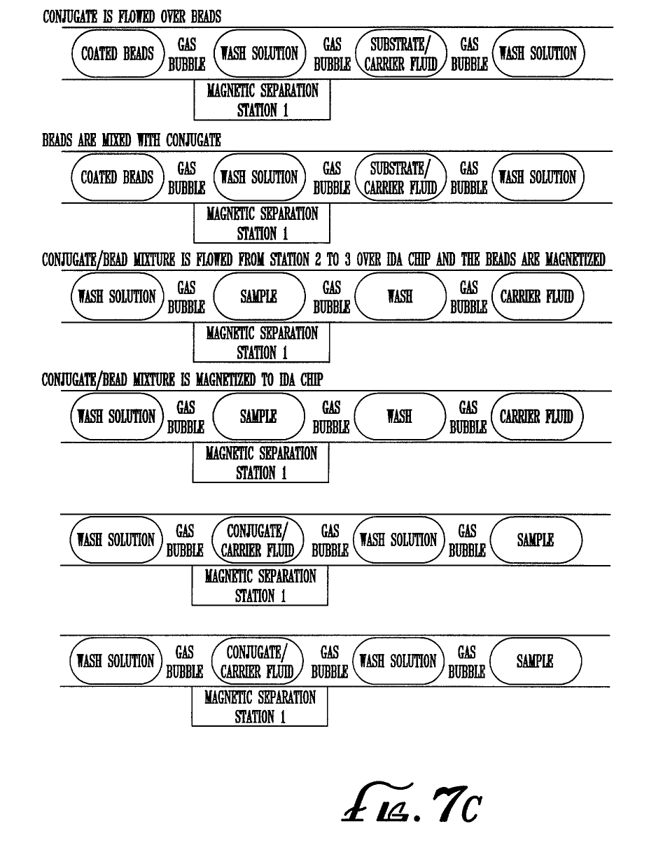

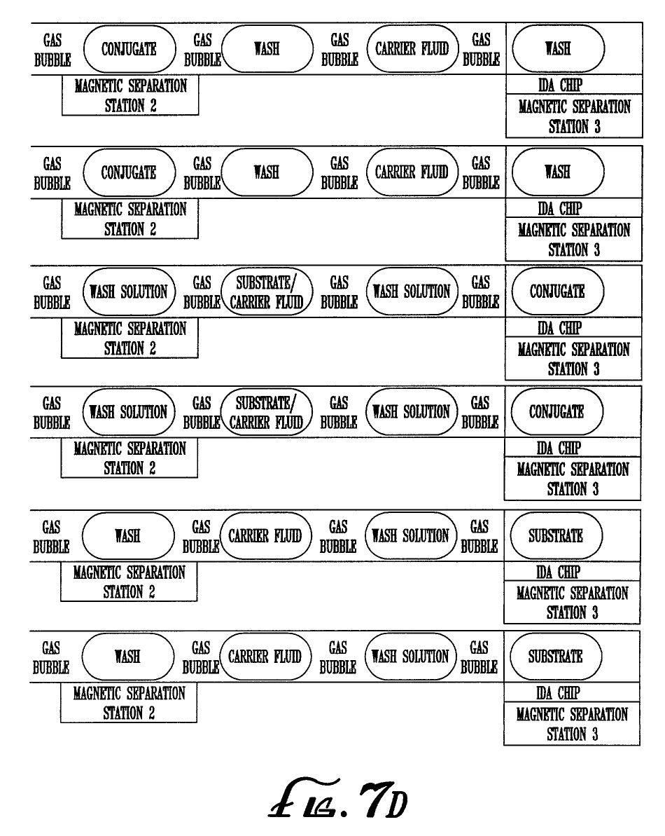

As shown in FIG. 7, an embodiment of the invention comprises forming linearly disposed discrete solution compartments within a conduit. Each solution compartment may be defined by interposing a separator, such as a gas bubble, within a carrier fluid at predetermined points. In this manner, the carrier fluid may be divided up into solution compartments, each of which is formed or sandwiched between two opposing gas bubbles within the conduit. The conduit, such as an inert tube, may be parallel to a ground surface, vertical to a ground surface, or even at an angle thereto. Preferably, the conduit is vertically positioned relative to a ground surface.

Each solution compartment may contain a different composition of materials, such as a sample or a conjugate, to respectively define a sample solution compartment or a conjugate solution compartment. At least one of the solutions compartments contains an attractable bead coated with a recognition molecule to define a coated bead solution compartment.

In operation, each of the solution compartments are transported over time, from left to right as seen in FIG. 7, within the conduit via a peristaltic pump or the like. An attraction device, such as a magnet, electromagnet, or the like, is disposed about the conduit. The attraction device, when actuated, is capable of attracting one or more of the attractable beads for processing/testing. The attraction device preferably contains a sensor, or IDA chip as described in detail supra. The sensor is capable of measuring the manipulated and processed beads after they have been transported through the conduit and/or subjected to the “conveyor belt” of discrete solution compartments.

Advantageously, as each of the solution compartments are transported within the conduit, due to the placement of the attraction device, the attraction device is capable of selectively retaining at least some of the attractable beads within the conduit. In this manner, the attracted attractable beads are effectively separated from the carrier fluid. As the carrier fluid continues to flow through the conduit, the next linearly disposed solution compartment can manipulate the temporarily restrained beads. For example, if the next linear solution compartment comprises a wash solution, the temporarily restrained beads will be washed. Similarly, if the solution compartment preceding the wash solution compartment contains a substrate/carrier fluid, the bathed and temporarily restrained beads can be subjected to the substrate/carrier fluid within the conduit.

As is apparent to one of ordinary skill in the art, such a conduit arrangement allows for the implementation of separate processing steps in an endless sequence that can be manipulated depending on the assay. The preferred linear order of the solution compartments, as illustrated in FIG. 7 from left to right, is as follows: a substrate/carrier fluid compartment, a conjugate/carrier fluid compartment, a sample/carrier fluid compartment, and a bead compartment. Most preferably, a wash solution compartment separates each of the four identified material-containing solution compartments. Multiple attraction devices are also preferably used to facilitate improved processing techniques.

In sum, the preferred operational steps of this embodiment of the invention, as illustrated in FIG. 7, are as follows: (1) transporting a coated bead solution compartment to a first separation station having an actuatable attraction device; (2) actuating the attraction device to attract some of the coated beads in the coated bead solution compartment such that some of the coated beads are temporarily restrained within the first separation station and separated from the carrier fluid; (3) flowing a wash solution compartment into the first separation station; (4) flowing a sample/carrier fluid solution compartment over the attracted beads; (5) actuating the attraction device to release the temporarily restrained beads into the sample solution compartment; (6) flowing the sample/bead mixture from the first separation station preferably to a second separation station having an actuatable attraction device; (7) actuating the second attraction device to attract some of the coated beads such that some of the coated beads are temporarily restrained within the second separation station; (8) flowing a wash solution compartment into the second separation station; (9) flowing a conjugate/carrier fluid solution compartment over the attracted beads; (10) actuating the second attraction device to release the temporarily restrained beads into the conjugate/carrier fluid solution compartment; (11) flowing the conjugate/bead mixture from the second separation station to a third separation station that preferably has a third actuatable attraction device having a sensor; (12) actuating the third actuatable attraction device to attract some of the beads, or more specifically, some of the bead/antigen/antibody/enzyme complex, to the vicinity of the sensor; (13) flowing a wash solution compartment into the third separation station; (14). flowing a substrate/carrier fluid solution compartment over the attracted beads, which in the presence of the enzyme is cleaved into a reporter molecule capable of exhibiting redox recycling, and (15) measuring the presence or amount of electrochemical with the sensor, wherein the sensor produces redox recycling of the electrochemical.

Thus, devices and methods for detecting and quantitating analytes in a sample are disclosed. While embodiments and applications of this invention have been shown and described, it will be apparent to those skilled in the art that many modifications are possible without departing from the inventive concepts herein. The invention, therefore is not to be restricted except in the spirit of the appended claims.

We claim:

1. An electrochemical reporter device comprising:
(a) a chamber for receiving an analytical reaction including magnetic beads;
(b) a sensor within the chamber, the sensor for detecting electrochemical reporter molecules within the chamber and the sensor having a configuration such that reporter molecules capable of exhibiting redox recycling will undergo redox recycling if within the chamber; and
(c) a magnetic field generating device selectively positioned such that magnetic beads present within the chamber will be attracted to the surface of the chamber wherein the sensor is located.

2. The electrochemical reporter device of claim 1, the sensor being a microelectronic interdigitated array of electrodes with a distance between the electrodes of about 100 to about 800 nanometers.

3. The electrochemical reporter device of claim 2, the sensor being a microelectronic interdigitated array of electrodes having a distance between the electrodes of about 300 nanometers.

4. An electrochemical reporter system comprising:
(a) a magnetic bead;
(b) a recognition molecule capable of specifically binding an analyte in a structure restricted manner, the recognition molecule being linked to the magnetic bead;
(c) an enzyme;
(d) a coupling element, for coupling with specificity the enzyme to the recognition molecule or the analyte;
(e) a substrate which in the presence of the enzyme is cleavable into a reporter molecule capable of exhibiting redox recycling;
(f) a sensor for detecting the electrochemical reporter molecule, said sensor having a configuration such that the reporter molecule will exhibit redox recycling; and
(g) a magnetic field generating device positioned such that the magnetic beads may be attracted to the vicinity of the sensor.

5. The electrochemical reporter system of claim 4, the sensor being a microelectronic interdigitated array of electrodes with a distance between the electrodes of between about 100 to about 800 nanometers.

6. The electrochemical reporter system of claim 5, the distance between the electrodes being about 300 nanometers.

7. The electrochemical reporter system of claim 4, the enzyme being capable of effecting the cleavage of a covalent bond of the substrate.

8. The electrochemical reporter system of claim 7, the enzyme being selected from the group consisting of α-galactosidase, β-galactosidase, α-glucosidase, β-glucosidase, α-mannosidase, β-mannosidase, acid phosphatase, alkaline phosphatase and phosphodiesterase II.

9. The electrochemical reporter system of claim 4, the substrate being selected from the group consisting of p-aminophenyl-β-D-galactopyranoside, p-aminophenyl-α-D-galactopyranoside, p-aminophenyl-α-D-glucopyranoside, p-aminophenyl-β-D-glucopyranoside, p-aminophenyl-α-D-mannopyranoside, p-aminophenyl -β-D-mannopyranoside, p-aminophenylphosphate, and p-aminophenylphosphorylcholine.

10. The electrochemical reporter system of claim 1, the recognition molecule being selected from the group consisting of a protein, a polypeptide, a nucleic acid, a nucleic acid analog, a hapten, immunoglobulin, fragments of immunoglobulin, non-immunoglobulin binding proteins, cell adhesion molecules, receptors, non-biologic binding molecules, nucleic acids, nucleic acid analogs and a hormone.

11. The electrochemical reporter system of claim 4, the substrate being cleaved into at least one component comprising para-aminophenol.

12. The electrochemical reporter system of claim 4, the sensor being a microelectronic interdigitated array of electrodes having width between about 100 and about 800 nanometers and spaced between about 100 and about 800 nanometers from each other.

13. An assay for detecting or quantitating a specific analyte in a sample comprising the steps of:
a) a primary incubation, wherein magnetic beads coated with a recognition molecule that specifically binds an analyte are incubated with a sample;
b) a secondary incubation, wherein the magnetic beads are incubated with a conjugate comprising an enzyme, and a molecule that specifically binds the analyte, or the analyte/recognition molecule complex;
c) capturing the magnetic beads with a magnet over a sensor capable of producing redox recycling of an electrochemical capable of undergoing redox recycling;
d) adding a substrate, said substrate in the presence of the enzyme being cleaved into an electrochemical capable of undergoing redox recycling; and
e) detecting the presence or measuring the amount of electrochemical present in the solution with said sensor, wherein the steps a and b may be conducted simultaneously.

14. The assay of claim 13, the primary incubation lasting less than 10 minutes.

15. The assay of claim 13, the secondary incubation lasting less that 10 minutes.

16. The electrochemical reporter system of claim 13, the recognition molecule being selected from the group consisting of a protein, a polypeptide, a nucleic acid, a nucleic acid analog, a hapten, immunoglobulin, fragments of immunoglobulin, non-immunoglobulin binding proteins, cell adhesion molecules, receptors, non-biologic binding molecules, nucleic acids, nucleic acid analogs and a hormone.

17. The electrochemical reporter system of claim 13, the enzyme being capable of effecting the cleavage of a covalent bond of the substrate.

18. The electrochemical reporter system of claim 17, the enzyme being selected from the group consisting of α-galactosidase, β-galactosidase, α-glucosidase, β-glucosidase, α-mannosidase, β-mannosidase, acid phosphatase, alkaline phosphatase and phosphodiesterase II.

19. The electrochemical reporter system of claim 13, the substrate being selected from the group consisting of p-aminophenyl-β-D-galactopyranoside, p-aminophenyl-α-D-galactopyranoside, p-aminophenyl-α-D-glucopyranoside, p-aminophenyl-β-D-glucopyranoside, p-aminophenyl-α-D-mannopyranoside, p-aminophenyl-β-D-mannopyranoside, p-aminophenylphosphate, and p-aminophenylphosphorylcholine.

20. The electrochemical reporter system of claim 13 wherein the substrate is cleaved into at least one component comprising para-aminophenol.

21. The electrochemical reporter system of claim 13 wherein the sensor is a microelectronic interdigitated array of electrodes having width between about 100 and about 800 nanometers and spaced between about 100 and about 800 nanometers from each other.

22. An electrochemical immunoassay for detecting an analyte in a sample comprising the steps of:
(a) having linked to a magnetic bead an antigen with an antibody specific for an analyte bound to the antigen, the antibody being coupled to an enzyme or having a coupling element for being specifically coupled to an enzyme;
(b) contacting the magnetic bead/antigen/antibody/enzyme complex with a sample to be analyzed;
(c) collecting the magnetic bead/antigen/antibody/enzyme complex;
(d) attracting the magnetic bead/antigen/antibody/enzyme complex to the vicinity of a sensor;
(e) adding a substrate to the collected magnetic bead/antigen/antibody/enzyme complex, the substrate in the presence of the enzyme being cleavable into a reporter molecule capable of exhibiting redox recycling; and
(f) measuring the presence or amount of reporter molecule with the sensor, the sensor being an interdigitated array of electrodes capable of producing redox recycling of the reporter molecule.

23. An electrochemical assay for detecting a specific analyte in a sample comprising the steps of:
(a) having a recognition molecule linked to a magnetic bead, said recognition molecule capable of specifically binding the analyte in a structure restricted manner;
(b) contacting the magnetic bead with a sample to be analyzed;
(c) coupling with specificity an enzyme to the recognition molecule or the analyte;
(d) attracting the magnetic bead/recognition molecule/analyte/enzyme conjugate complex to the vicinity of a sensor with a device capable of generating a magnetic field;
(e) adding a substrate, which in the presence of the enzyme is cleaved into a reporter molecule capable of exhibiting redox recycling; and
(f) measuring the presence or amount of electrochemical with the sensor, wherein the sensor is an interdigitated array of electrodes capable of producing redox recycling of the electrochemical.

24. The electrochemical reporter system of claim 23, the recognition molecule being selected from the group consisting of protein, a polypeptide, a nucleic acid, a nucleic acid analog, a hapten, immunoglobulin, fragments of immunoglobulin, non-immunoglobulin binding proteins, cell adhesion molecules, receptors, non-biologic binding molecules, nucleic acids, nucleic acid analogs and a hormone.
